(19) United States
(12) Patent Application Publication
(10) Pub. No.: US 2023/0376365 A1
(43) Pub. Date: Nov. 23, 2023

(54) MICROSERVICES

(71) Applicant: Simple Things Inc., Palo Alto, CA (US)

(72) Inventors: Kristopher LINQUIST, Santa Clara, CA (US); Joel Buchheim-Moore, San Francisco, CA (US); Yateesh Chandraiah, San Jose, CA (US); Omer Akram, Multan (PK); Volodymyr Ishchenko, Kharkiv (UA); Oleksii Parshyn, Kharkiv (UA); Avinash Shetty, San Jose, CA (US); Mike Eynon, Woodside, CA (US); Andrew Rubin, Woodside, CA (US); James Zhang, Carlsbad, CA (US)

(21) Appl. No.: 18/322,398

(22) Filed: May 23, 2023

Related U.S. Application Data
(60) Provisional application No. 63/365,191, filed on May 23, 2022.

(51) Int. Cl. G06F 9/54

(52) U.S. Cl. CPC G06F 9/547; G06F 9/546

(57) ABSTRACT

A computer system of a hub determines that a smart device has been installed in proximity to the hub. A first remote procedure call (RPC) is sent from the hub to an adapter of the smart device using a first microservice to install the adapter. The first RPC is sent over a hub Web Application Messaging Protocol (WAMP) router of the hub. A second RPC is sent from the hub to the adapter using a second microservice to determine that the adapter is functional. An automated flow is accessed for controlling the smart device. The automated flow comprises a node corresponding to the smart device. A third RPC is sent from the hub via the adapter to the smart device using a third microservice. The third RPC references the node. The smart device is operated in accordance with the automated flow using the third RPC.

### CROSS-REFERENCE TO RELATED APPLICATION

This application claims priority to and the benefit of U.S. Provisional Patent Application No. 63/365,191, filed on May 23, 2022, which is incorporated by reference herein in its entirety.

### TECHNICAL FIELD

Various of the disclosed embodiments concern microservices that associate an action of a user-interface (UI) element to a transport protocol layer such as a Web Application Messaging Protocol (WAMP) call. Such microservices can be connected via a flow.

### BACKGROUND

A major challenge in developing a service, such as a control panel for a system such as a security system, concerns how the service is integrated into the system. One way to do this is to create a webpage that includes all needed features of the service, e.g. buttons. However, the webpage must be hosted and then accessed to use the service. As such, the service is dependent upon a connection to the Internet.

Developers can create an app for the service and then put the app in an app store to distribute the app. However, this is costly and time consuming. Further, apps typically are not permitted to execute code. Thus, any actions taken via the app must be executed away from the device that hosts the app, e.g. in a server, where the interaction between the server and the device is dependent upon a connection to the Internet.

### BRIEF DESCRIPTION OF THE DRAWINGS

One or more embodiments of the present disclosure are illustrated by way of example and not limitation in the figures of the accompanying drawings, in which like references indicate similar elements.

FIG. 1 is a block diagram illustrating an example system architecture, in accordance with one or more embodiments.

FIG. 2 is a drawing illustrating an example hub, in accordance with one or more embodiments.

FIG. 3 is a drawing illustrating example microservices, in accordance with one or more embodiments.

FIG. 4 is a flow diagram illustrating an example process, in accordance with one or more embodiments.

FIG. 5 is a block diagram illustrating an example machine learning system, in accordance with one or more embodiments.

FIG. 6 is a block diagram illustrating an example computer system, in accordance with one or more embodiments.

### DETAILED DESCRIPTION

Various example embodiments will now be described. The following description provides certain specific details for a thorough understanding and enabling description of these examples. One skilled in the relevant technology will understand, however, that some of the disclosed embodiments may be practiced without many of these details.

Likewise, one skilled in the relevant technology will also understand that some of the embodiments may include many other obvious features not described in detail herein. Additionally, some well-known structures or functions may not be shown or described in detail below, to avoid unnecessarily obscuring the relevant descriptions of the various examples.

The terminology used below is to be interpreted in its broadest reasonable manner, even though it is being used in conjunction with a detailed description of certain specific examples of the embodiments. Indeed, certain terms may even be emphasized below; however, any terminology intended to be interpreted in any restricted manner will be overtly and specifically defined as such in this Detailed Description section.

Embodiments of the present disclosure will be described more thoroughly from now on with reference to the accompanying drawings. Like numerals represent like elements throughout the several figures, and in which example embodiments are shown. However, embodiments of the examples can be embodied in many different forms and should not be construed as limited to the embodiments set forth herein. The examples set forth herein are non-limiting examples and are merely examples, among other possible examples. Throughout this specification, plural instances (e.g., “610”) can implement components, operations, or structures (e.g., “610a”) described as a single instance. Further, plural instances (e.g., “610”) refer collectively to a set of components, operations, or structures (e.g., “610a”) described as a single instance. The description of a single component (e.g., “610a”) applies equally to a like-numbered component (e.g., “610b”) unless indicated otherwise. These and other aspects, features, and implementations can be expressed as methods, apparatuses, systems, components, program products, means or steps for performing a function, and in other ways. These and other aspects, features, and implementations will become apparent from the following descriptions, including the examples.

Techniques to create and process microservices are provided. Each microservice has a manifest and each manifest has a list of UI elements with text input and attributes that associate an action of the UI element to a WAMP call. A developer can build UI elements and associates them to a section of an app, for example: provisioning a new device; configuring a device; implementing a dashboard to interact with the device; and performing automation, for example defining a UI element as a (i) trigger, e.g. “when door opens, do action,” (ii) condition, e.g. “as long as door is open, do action,” or (iii) action, e.g., “do action.”

In some embodiments, a computer system of a hub determines that a smart device has been installed in proximity to the hub. A first remote procedure call (RPC) is sent from the hub to an adapter of the smart device using a first microservice to install the adapter. The first RPC is sent over a hub Web Application Messaging Protocol (WAMP) router of the hub. A second RPC is sent from the hub to the adapter using a second microservice to determine that the adapter is functional. An automated flow is accessed for controlling the smart device. The automated flow comprises a node corresponding to the smart device. A third RPC is sent from the hub via the adapter to the smart device using a third microservice. The third RPC references the node. The smart device is operated in accordance with the automated flow using the third RPC.

The advantages and benefits of the methods, systems, and apparatuses disclosed herein include the prevention of services running on the cloud or a third-party device from connecting to the hub in a building or home. Therefore, no ports in a router are opened to the external Internet, and ports are prevented from exposure to external attack by malicious entities. Moreover, implementation of a static internet protocol (IP) address is obviated. Several mechanisms are implemented by the WAMP routers and protocols to isolate components and avoid man-in-the-middle attacks. Default implementations ensure that trying to register an already-registered procedure will fail.

Combining the Publish/Subscribe (pub/sub) and routed Remote Procedure Calls in a Web-native, real-time transport protocol (WebSocket) allows WAMP to be used for messaging requirements of component- and microservice-based applications, reducing technology stack complexity and overhead, providing a capable and secure fundament for applications to rely on, Because flow-based programming (FBP) processes can continue executing as long they have data to work on and space for their output, FBP applications can run in less elapsed time than conventional programs, and make optimal use of all the processors on a machine, with no special programming required to achieve this. In addition, the advantages of the convolutional neural network (CNN) used for machine learning (ML) in the disclosed embodiments include the obviation of feature extraction and the use of shared weight in convolutional layers, which means that the same filter (weights bank) is used for each node in the layer; the weights bank both reduces memory footprint and improves performance.

### Platform Services

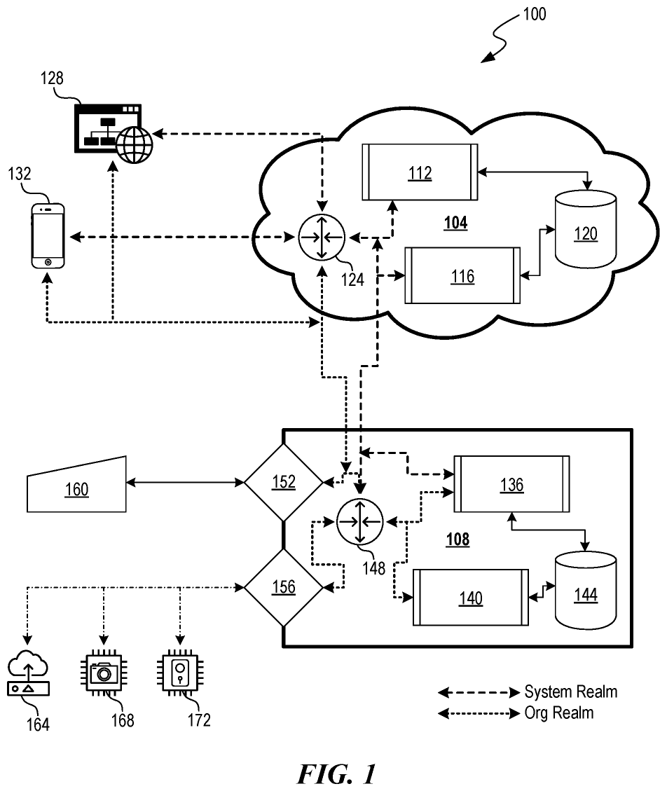

FIG. 1 is a block diagram illustrating an example system architecture 100, in accordance with one or more embodiments. An embodiment of microservices can be understood with reference to system architecture 100 in which microservices are implemented, consistent with embodiments herein. An exemplary platform provides many services for a developer and for a consumer. Some of these services are in the cloud as Web Application Messaging Protocol (WAMP) microservices and others run on the hub as a WAMP application component or as WAMP microservices.

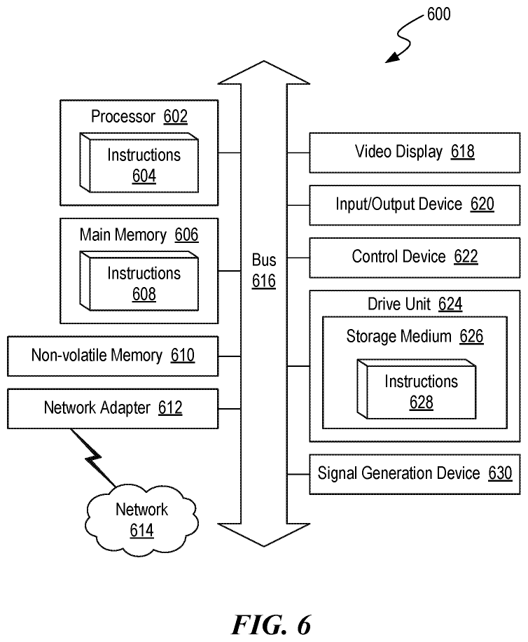

The architecture 100 includes a hub 108, smart devices 164, 168, 172, and a cloud computing system 104. The smart device 164 is a smart sensor, the smart device 168 is a smart camera, and the device 172 is a smart lock (e.g., for a door, window, safe, or cabinet). In some embodiments, architecture 100 includes other smart devices such as a water sprinkler, a door alarm, a security camera, a music player, or a smart speaker. The architecture 100 is implemented using the components of the example computer system 600 illustrated and described in more detail with reference to FIG. 6. Likewise, embodiments of the architecture 100 can include different and/or additional components or can be connected in different ways.

### Cloud

The cloud comprises one or more remote, globally distributed, fault tolerant, and scalable servers that host global services. The cloud communicates with mobile apps, web apps, and hubs via WAMP over a web socket. In FIG. 1, cloud computing system 104 includes a WAMP router 124 and is in communication with an account service 112 and a device registry 116, each of which has access to an open-source object-relational database 120 (e.g., a PostgreSQL open-source object-relational database). The cloud server communicates with mobile apps 132 and web apps 128.

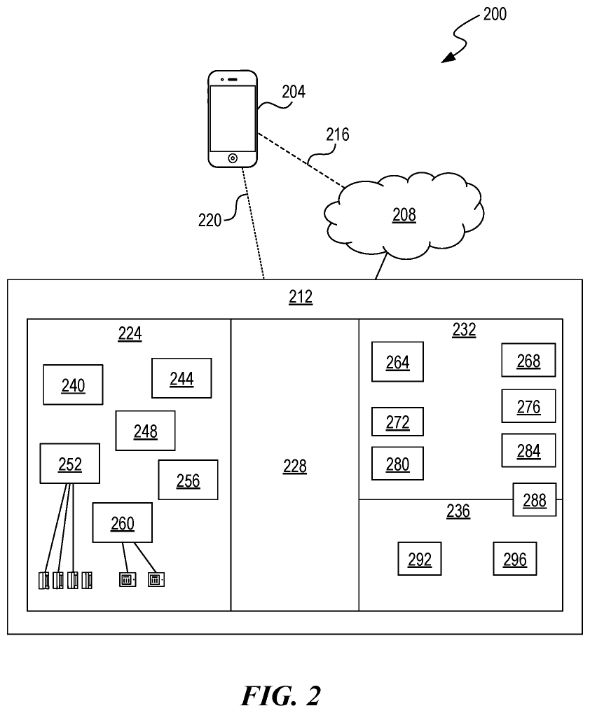

The cloud computing system 104 provides the delivery of computing services—including servers, storage, databases, networking, software, analytics, and intelligence—over the Internet to offer faster innovation, flexible resources, and economies of scale. The cloud computing system 104 includes WAMP router 124 and is in communication with an account service 112 and a device registry 116, each of which has access to an open-source object-relational database 120 (e.g., a PostgreSQL open-source object-relational database). The cloud computing system 104 communicates with mobile apps 132 and web applications (web apps 128) operating on user devices. The router 124 is a WAMP router that facilitates communication between the web apps 128, mobile apps 132 on a user device, the account service 112, the device registry 116, the cloud computing system 104, and the hub 108. An example user device 204 is illustrated and described in more detail with reference to FIG. 2.

### Hub

The hub comprises a computer (e.g., a small computer) that is installed in a home or building and hosts first and third-party application services. The hub communicates with system devices and sensors such as contact sensors, motion (radar) sensors, cameras, etc., via Low Power, Wide Area Long Range (LoRA) communication or USB. In FIG. 1, a hub 108 includes a WAMP router 148 in communication with core services, also referred to microservices 136 and an alarm service 140, each of which has access to a local SQLite database 144. Hub 108 communicates with zone inputs 160 via a USB port 152 and communicates with sensors 164, a camera 168, and door locks 172 via a wireless protocol connection 156, e.g., a LoRa networking protocol connection or a Zigbee networking protocol connection.

The hub 108 includes a WAMP router 148 in communication with core services, also referred to as microservices 136, and an alarm service 140, each of which has access to a local SQLite database 144. Example microservices and an example alarm service (microservices 232, microservice 280) are described in more detail with reference to FIG. 2. The hub 108 communicates with zone inputs 160 via a USB port 152 and communicates with sensor(s) 164, camera 168, and door lock(s) 172 via a wireless protocol connection 156, e.g., a Long Range (LoRa) networking protocol connection or a Zigbee networking protocol connection. In some embodiments, at least one of the hub 108 or smart devices 164, 168, 172 receives electrical power and network connectivity via a universal serial bus (USB) type C port.

A smart device (e.g., sensor(s) 164, camera 168, or door lock 172) can be connected to hub 108 using LoRa communication. LoRa is a physical proprietary radio communication technique based on spread spectrum modulation techniques derived from chirp spread spectrum (CSS) technology. LoRa-WAN defines a communication protocol and system architecture. Together, LoRa and LoRa-WAN define a Low Power, Wide Area (LPWA) networking protocol designed to wirelessly connect battery operated devices to the Internet in regional, national or global networks, and targets key Internet of things (IOT) requirements such as bi-directional communication, end-to-end security, mobility and localization services. The low power, low bit rate, and IoT use distinguish this type of network from a wireless WAN that is designed to connect users or businesses, and carry more data, using more power. The LoRa-WAN data rate ranges from 0.3 kbit/s to 50 kbit/s per channel.

Any other smart home gadgets and devices are operated similarly using the embodiments disclosed herein, e.g., smart speakers, entertainment systems, surveillance systems, sprinkler systems for a garden, smart refrigerators and other smart home appliances, smart mirrors, smart locks, smart lighting, smart entry systems, climate control systems, smart detectors, smart sensors, or smart Internet routers. The WAMP router 148 facilitates communication between the microservices 136, the alarm service 140, the USB port 152, the wireless protocol connection 156, the cloud computing system 104, and the hub 108. In an embodiment, when there is no Internet service, the microservices 136 can still run or execute inside the premises because of WAMP router 148 on hub 108.

The WAMP pub/sub OTA messaging updates the UI of the mobile app 132 over a wireless network. The WAMP pub/sub OTA messaging can be used for different embedded systems including mobile phones, tablets, or set-top boxes. In some embodiments, firmware updates can be delivered OTA. In some embodiments, a device's operating system, applications, configuration settings, or parameters such as encryption keys can be updated. OTA updates are usually performed over Wi-Fi or a cellular network, but can also be performed over other wireless protocols, or over the local area network.

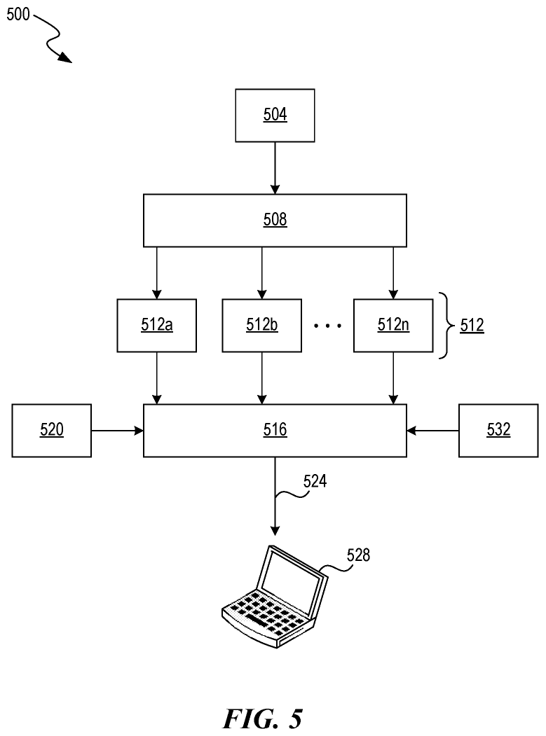

In some embodiments, the WebSocket protocol is used to deliver bi-directional (soft) real-time and wire traffic connections to mobile app 132. WAMP provides application developers with a level of semantics to address messaging and communication between components in distributed applications. WAMP provides PubSub functionality as well as routed Remote Procedure Calls (rRPCs) for procedures implemented in WAMP router 148. RPCs are described in more detail with reference to FIG. 5. Publish/Subscribe (PubSub) is a messaging pattern where a component, the Subscriber, informs WAMP router 148 that it wishes to subscribe to a topic. Another component, a Publisher, publishes to this topic, and the router distributes events to all Subscribers.

In some embodiments, text or graphical input is received from a user input device. The user input device can be user device 204 (see FIG. 2), another user input device such as mounted on a wall of a building or embedded in furniture, or part of another device such as a music system. The text or graphical input references a smart device (e.g., smart lock 172). A new RPC based on the text or graphical input is sent from a microservice to the cloud WAMP router 124 over the WebSocket connection. The cloud WAMP router 124 is caused to route the new RPC into hub 108. For example, the microservice is caused to establish a WebSocket connection to the cloud WAMP router 124. The microservice can execute on hub 108. In some embodiments, the microservice is precluded from executing on a software Snap™ package. An adapter (e.g., adapter 224 of FIG. 2) executes on the cloud (e.g., cloud computing system 104) or on a computer device (e.g., user device 204 of FIG. 2) of a user. A portion of an automated flow corresponding to the smart device (e.g., smart lock 172) can be modified. The automated flow is generated using flow-based programming (FBP) as described herein.

In some embodiments, hub 108 determines that smart lock 172 is a third-party device or legacy door lock. Responsive to determining that a third-party device is installed, a user interface (UI) of mobile application 132 of a user device of a user is reconfigured using WAMP pub/sub messaging delivered over-the-air (OTA) to incorporate a UI widget corresponding to smart lock 172. An example user device 204 is illustrated and described in more detail with reference to FIG. 2. A user input device can also receive text or graphical input via a UI widget on the user input device. The user input device can be user device 204 or another user input device. The UI widget (also known as a graphical control element or a control) in a graphical user interface (GUI) is an element of interaction, such as a button or a scroll bar. Controls are software components that a computer user interacts with through direct manipulation to read or edit information about an application.

In some embodiments, the text or graphical input references a smart device (e.g., smart lock 172). The user input device is caused to send a new RPC based on the text or graphical input from the user input device to hub 108 over the hub WAMP router 148 for hub 108 to execute the RPC, while precluding the RPC executing on the user input device. For example, cloud data stored in the cloud (e.g., using the cloud computing system 104 illustrated and described in more detail with reference to FIG. 1) is accessed using hub 108 while the cloud is precluded from accessing hub data stored in hub 108.

### Security and Privacy via WAMP URIs

In some embodiments, access control is via statis authorization. The adapter or service manifest requests permissions that are approved by a user. Upon approval, the resource manager generates the dynamic authorization. A default permission can exist to allow an adapter or service to publish within its own namespace.

URIs contain adapter Ids and/or devices or elements of the platform's UUIDs for granular control. For example, the Activity Service or Mobile App may want access to all events. Such Activity Service or Mobile App can be given the following permissions, as shown in Table A.

TABLE A

```
{
  “uri”: “com.thing.adapter.*.*.events”,
  “allow”: {
    “call”: false,
    “register”: false,
    “subscribe”: true,
    “publish”: false
  }
}
```

However, as an example the user may install a license plate recognition application that should only access events from one of the cameras. Therefore, the wildcards could be removed in the above code block. A sample adapter with the adapterId st-contact-closure could have the following permissions, as shown in Table B.

TABLE B

```
{
  “uri”: “com.thing.adapter.st-contact-closure.*.set”,
  “allow”: {
    “call”: false,
    “register”: true,
    “subscribe”: false,
    “publish”: false
},
{
  “uri”: “com.thing.adapter.st-contact-closure.*.get”,
  “allow”: {
    “call”: false,
    “register”: true,
    “subscribe”: false,
    “publish”: false
},
{
  “uri”: “com.thing.adapter.st-contact-closure.*.events”,
  “allow”: {
    “call”: false,
    “register”: false,
    “subscribe”: false,
    “publish”: true
}
```

### Service SDK

In an embodiment, any microservice that speaks WAMP uses a Service SDK. This standardizes the WAMP communications including authorization, disconnect logic, etc. In some embodiments, an operating system (OS) of hub 108 is updated using an incremental code update delivered OTA in a software Snap™ package. The OS manages software and hardware of the hub 108 and performs basic tasks such as file, memory and process management, handling input and output, and controlling peripheral devices (e.g., smart devices 164, 168, 172). Snap™ is a software packaging and deployment system for operating systems that use the Linux kernel and the systemd init system. The packages, called snaps, and the tool for using them, snapd, work across a range of Linux™ distributions and allow upstream software developers to distribute their applications directly to users. Snaps are self-contained applications running in a sandbox with mediated access to the host system. Snap™ is operable for cloud applications, Internet of Things devices, and desktop applications.

In some embodiments, a smart device (e.g., smart device 168) includes a 60 gigahertz (GHz) radar sensor. The radar sensor includes an antenna that emits a high-frequency (60 GHz) transmitted signal, which can include a modulated signal with a lower frequency (10 MHz). The sensor can be used to detect motion of people, animals, or objects within rooms of a home or building over a number of days using the 60 GHz radar sensor. Patterns of the motion of people, animals, or objects are generated based on detecting the motion. In some embodiments, feature vectors are extracted from the patterns of the motion. An example feature vector 512 and example input data 504 is illustrated and described in more detail with reference to FIG. 5. A machine learning model is trained, based on the feature vectors, to detect movement of the people, the animals, or the objects within the rooms especially when the movement mismatches the predicted patterns of the motion. An example machine learning model 516 is illustrated and described in more detail with reference to FIG. 5. In some embodiments, features are extracted from data captured by the 60 GHz radar sensor. A notification is sent using the machine learning model to user device 204 based on the features. The notification indicates a mismatch detected in the features.

In some embodiments, feature vectors are extracted from training images depicting persons, animals, or objects associated with the home or building. Feature extraction is performed as described in more detail with reference to FIG. 5. A machine learning model is trained, based on the feature vectors, to detect new persons, new animals, or new objects that the training images are free of. A smart device can be a security camera. Features are extracted from a video captured by the security camera. A notification is generated using the machine learning model to user device 204 based on the features. The notification indicates that a new person, a new animal, or a new object has been detected in the video.

In some embodiments, operating a smart device (e.g., smart camera 168) and a third-party device (e.g., smart door lock 172) obviates the need for an Internet connection to the hub 108. Hub 108 can communicate with the smart device and the third-party device using short-range wireless communication. The short-range wireless communication can be near field communication (NFC), Zigbee, Bluetooth, Wi-Fi, radio frequency identification (RFID), Z-wave, infrared (IR) wireless, 3.84 MHz wireless, EMV chips, or minimum-shift keying (MSK). NFC is a set of communication protocols for communication between two electronic devices over a distance of 4 cm or less. NFC devices can act as electronic identity documents or keycards. NFC is based on inductive coupling between two antennas present on NFC-enabled devices-for example a smartphone and an NFC card-communicating in one or both directions, using a frequency of 13.56 MHz in the globally available unlicensed radio frequency ISM band using the ISO/IEC 18000-3 air interface standard at data rates ranging from 106 to 424 kbit/s. An NFC-enable devices, such as a smartphone (NFT creator device) can act like an NFC card, allowing users to perform transactions such as payment or ticketing.

Zigbee is a wireless technology developed as an open global standard to address the unique needs of low-cost, low-power wireless IoT networks. The Zigbee standard operates on the IEEE 802.15.4 physical radio specification and operates in unlicensed bands including 2.4 GHz, 900 megahertz (MHz) and 868 MHz. Bluetooth technology is a high-speed low powered wireless technology link that is designed to connect phones or other portable equipment together. The Bluetooth specification (IEEE 802.15.1) is for the use of low-power radio communications to link phones, computers, and other network devices over short distances without wires. Wireless signals transmitted with Bluetooth cover short distances, typically up to 30 feet (10 meters). It is achieved by embedded low-cost transceivers into the devices. Wi-Fi is a family of wireless network protocols, based on the IEEE 802.11 family of standards, which are commonly used for local area networking of devices and Internet access, allowing nearby digital devices to exchange data by radio waves.

RFID uses electromagnetic fields to automatically identify and track tags attached to objects. An RFID system consists of a tiny radio transponder, a radio receiver and transmitter. When triggered by an electromagnetic interrogation pulse from a nearby RFID reader device, the tag transmits digital data back to the reader. Passive tags are powered by energy from the RFID reader's interrogating radio waves. Active tags are powered by a battery and thus can be read at a greater range from the RFID reader, up to hundreds of meters.

Z-Wave is a wireless communications protocol on a mesh network using low-energy radio waves to communicate from appliance to appliance, allowing for wireless control of devices. A Z-Wave system can be controlled via the Internet from a smart phone, tablet, or computer, and locally through a smart speaker, wireless key fob, or wall-mounted panel. IR wireless is the use of wireless technology in devices or systems that convey data through infrared (IR) radiation. Infrared is electromagnetic energy at a wavelength or wavelengths somewhat longer than those of red light. The shortest-wavelength IR borders visible red in the electromagnetic radiation spectrum; the longest-wavelength IR borders radio waves.

In additional embodiments, hub 108 receives speech input from a smart speaker. The speech input describes multiple asynchronous events associated with multiple smart devices (e.g., smart devices 164, 168, 172) in the architecture 100. The smart device 164 is a smart sensor, the smart device 168 is a smart camera, and the smart device 172 is a smart lock. Hub 108 is connected to a cloud WAMP router 124 located in a cloud computing system 104.

A smart speaker is a type of loudspeaker and voice command device with an integrated virtual assistant that offers interactive actions and hands-free activation with the help of one “hot word” (or several “hot words”). Some smart speakers can also act as smart devices that utilize Wi-Fi, Bluetooth and other protocol standards to extend usage beyond audio playback, such as to control home automation devices. The implementations can include, but are not limited to, features such as compatibility across a number of services and platforms, peer-to-peer connection through mesh networking, virtual assistants, and others. Each can have its own designated interface and features in-house, usually launched or controlled via application or home automation software. Some smart speakers also include a screen to show the user a visual response.

WAMP is a WebSocket subprotocol specified to offer routed RPC and PubSub messaging. It provides an open standard for soft, real-time message exchange between application components and eases the creation of loosely coupled architectures based on microservices. The WAMP router 124 is used as an enterprise service bus (ESB) for developing responsive Web applications or to coordinate multiple connected smart devices in the architecture 100. WAMP uses a reliable, ordered, full-duplex message channel as a transport layer, and by default uses WebSocket. However, implementations can use other transports matching these characteristics and communicate with WAMP over, for example, raw sockets, Unix sockets, or HTTP long poll. In some embodiments, message serialization uses integers, strings, and ordered sequence types, and defaults to JSON as a common format offering these. Implementations can provide MessagePack as a faster alternative to JSON.

WAMP is architected around client-client communications. The router 124 dispatches messages between the cloud computing system 104 and the hub 108. For data exchange, client microservices connect to the hub's WAMP router 148 using a transport, establishing a session. The router 148 is illustrated and described in more detail with reference to FIG. 1. The router 148 identifies the clients and gives them permissions for the current session. Clients send messages to the router 148, which dispatches them to the proper targets using the attached URIs. The clients send these messages using the two high-level primitives that are RPC and Pub/Sub, doing four core interactions: (1) register: a client exposes a procedure to be called remotely, (2) call: a client asks the router 148 to get the result of an exposed procedure from another client, (3) subscribe: a client notifies its interest in a topic, and (4) publish: a client publishes information about the topic.

### Realms

WAMP RPCs and WAMP Publish/Subscribe (PubSub), WAMP's two messaging patterns, occur in a realm. Consistent with embodiments herein, a realm is like a namespace, e.g., com.thing.system, which provides isolation for RPCs and PubSub. A client connects to a realm and calls/registers RPCs and subscribes/publishes to PubSub in that realm. Users may have access to multiple realms, depending on the number of organizations to which they belong.

FIG. 1 shows a system realm (larger dash lines) and an organization realm (smaller dash lines). In the organizational realm the hub and cloud server communicate with each other via their respective WAMP routers. Within the organizational realm the mobile app and web app can communication directly with the hub via the hub's WAMP router and the zone input can communicate directly with the cloud server via the cloud server's WAMP router. The organizational realm in the embodiment shown in FIG. 1 implements an alarm service at the hub. Those skilled in the art will appreciate that other services may be implemented with the architecture disclosed herein. Examples of such other services include but are not limited to sprinkler system integration, speaker system integration, and light bulb system integration. The system realm provides system services, such as those provided by the account service and device registry at the cloud server and the core services (e.g., alarm service and provisioning service) at the hub.

As WAMP uses WebSocket, connections can be wrapped in Transport Layer Security (TLS) for encryption. TLS is the successor protocol to Secure Sockets Layer (SSL). TLS is an improved version of SSL. It works in much the same way as the SSL, using encryption to protect the transfer of data and information. In some embodiments, hub 108 corresponds to a first realm, and a second, different hub corresponds to a second realm. A “realm” refers to a WAMP routing and administrative domain, optionally protected by authentication and authorization. WAMP messages are typically routed within a Realm.

The second hub is precluded from accessing the hub 108 or the first realm. The one or more processors enable hub 108 and the second hub to access a service realm corresponding to the cloud. For example, WAMP router 148 can define realms as administrative domains, and clients must specify which realm they want to join upon connection. Once joined, the realm will act as a namespace, preventing clients connected to a realm from using IDs defined in another realm for RPC and PubSub. In some embodiments, a first adapter operating a first smart device 164 is prevented from communicating with a second adapter operating a second smart device 168 of the architecture 100. For example, realms also have permissions attached and can limit the client microservices to one subset of the REGISTER/CALL/PubSub actions available. Some realms can only be joined by authenticated clients, using various authentication methods such as using TLS certificate, cookies or a simple ticket.

Hub 108 can convert the multiple asynchronous events to at least one of a trigger, a condition, or an action to be performed by one of the multiple smart devices 164, 168, 172. Smart sensor 164 produces an output signal for the purpose of sensing a physical phenomenon. The smart sensor 164 is a module, machine, or subsystem that detects events or changes in its environment and sends the information to other electronics, frequently a computer processor. The sensor 164 is used in everyday objects such as touch-sensitive elevator buttons (tactile sensor) and lamps which dim or brighten by touching the base, and in innumerable applications. With advances in micromachinery and the easy-to-use architecture 100, the uses of sensors 164 include temperature, pressure, potentiometers and force-sensing resistors, sensors that measure chemical and physical properties, optical sensors, vibrational sensors, and electro-chemical sensors.

The smart lock 172 pairs with the hub 108 for entry without a key, and to manage access to the lock 172 remotely. In some embodiments, the lock 172 is retrofitted to a traditional lock instead of replacing the existing deadbolt, or has user code limits, automatic locking, or connects with an existing security system. In some embodiments, the smart camera 168 performs continuous recording, or has a motion sensor, a rechargeable battery, or apps that send a push notification to the hub 108 when something triggers the camera 168. In some embodiments, the camera 168 has 1080p resolution or better and connects to an existing smart home setup or smart devices. A trigger refers to procedural code that is automatically executed in response to an event such as a rising edge on a signal. A condition refers to a material conditional (also known as material implication) and serves as the basis for commands in programming languages. An action refers to a step performed by the hub 108, or smart devices 164, 168.

In some embodiments, to generate an automated flow, one or more processors extract a feature vector from the speech input. An example feature vector 512 and example input data 504 is illustrated and described in more detail with reference to FIG. 5. The one or more processors generate a synchronous event using a machine learning model based on the feature vector to provide the automated flow. An example machine learning model 516 is illustrated and described in more detail with reference to FIG. 5. The machine learning model is trained to convert an asynchronous event to the synchronous event for controlling an adapter.

The adapter operates a smart device referenced by features input to the machine learning model. For example, an automated flow is generated for controlling an adapter from the trigger, the condition, or the action. An automated flow can be generated using a visual programming language. A graphical representation of the automated flow is generated for display to a user on a GUI of the smart building. The GUI is displayed on an electronic screen of the hub.

The adapter can operate a smart device. The smart device corresponds to a node in the automated flow. An adapter provides a programming interface to control and manage specific lower level interfaces linked to a smart device, e.g., smart sensor 164. In some embodiments, the adapter communicates with the smart sensor 164 through the communications subsystem to which the smart sensor 164 connects. When a calling program invokes a routine in the adapter, the adapter issues commands to the smart sensor 164. Once the smart sensor 164 sends data back to the adapter, the adapter invokes routines in the original calling program. An adapter provides the interrupt handling required for asynchronous time-dependent device behavior.

### Microservices

FIG. 2 is a drawing illustrating an example hub 212 in an architecture 200, in accordance with one or more embodiments. The architecture 200 is similar to or same as the architecture 100 illustrated and described in more detail with reference to FIG. 1. The architecture 200 includes a user device 204, a cloud computing system 208, and the hub 212. The architecture 200 is implemented using the components of the example computer system 600 illustrated and described in more detail with reference to FIG. 6. Likewise, embodiments of the architecture 200 can include different and/or additional components or can be connected in different ways.

Examples of microservices 232 include but are not limited to a resource manager 264 (e.g., a database with an API), a provisioning service 268, a groups service 276, a watchdog/bootstrap service 272 (e.g., ensures that the other microservices are running the way they are supposed to be running and permits the user to control whether a particular service is to start up at boot), an alarm service 280, and an activity service 284 (e.g., collects events from other microservices and then exposes such events as an activity list that can be localized).

In an embodiment, microservices can be written in Python and Javascript (e.g., flow services), etc. A service can be written entirely using FLOW. FLOW is the way a user can allow different microservices to talk to each other. For example, the door adapter can talk to the light adapter using a FLOW configured to receive an event from the lock adapter and send an event to the light adapter.

It should be appreciated that microservices are sandboxed, where a sandbox is a security mechanism for separating running programs. That is, microservices typically just access the transport protocol layer (e.g., WAMP). Also, in accordance with embodiments herein, some microservices are pre-loaded on the hub at manufacture. However, if a user decides to install any additional ones, they can be presented with a list of permissions requested by the microservice that the user has to approve to do the install.

In an embodiment, a flow runs in its own service. Also, in accordance with embodiments herein, there are three ways to write services. One is to write it on Python; to write a service using Javascript; and to write a service just entirely using flow.

An example of microservices connected to each other by a flow is as follows. A user might want an automation that says when my door opens turn on the light. The light adapter typically cannot talk to the door adapter. It has no idea about the door as the light adapter is in its own sandbox. Thus, the user can create a flow. Such flow can be configured to receive events from the door adapter then send the event to the light adapter. Thus, the innovation ensures that the user is fully in control of any data that gets shared, even between microservices.

In an embodiment, a microservice can be written in any programming language that runs on a particular operation system (e.g., such as Linux) and have a compatible transport protocol library, such as a WAMP library.

In an embodiment, the user can decide to send, give permission to send the write events to the cloud, so that microservices could be running outside of the hub. The innovation does not limit microservice to hub execution.

In an embodiment, a third party is enabled to create a microservice on the third party's cloud, e.g., the third party desires to have their code run on their own cloud. For example, such third party might want to have more control over their data. The platform is configured so that if the third party wants to run their microservice in the cloud, they just have to connect to the transport protocol (e.g., WAMP).

Embodiments of the innovation comprehend, create, and process microservices. Each microservice has a manifest and each manifest has a list of UI elements with text input and attributes that associate an action of the UI element to a WAMP call. A developer implementing embodiments of the innovation builds UI elements and associates them to a section of the app, for example:
Provisioning a new device, e.g. get name, serial no.;
Configuring a device, e.g. sensor on a door/window;
Implementing a dashboard to interact with the device;
Performing automation, e.g. defining a UI element as a (i) trigger, e.g. “when door opens, do action,” (ii) condition, e.g. “as long as door is open, do action,” or (iii) action, e.g., “do action.”

### Adapters

In an embodiment, the platform (e.g., architecture 100) runs microservices and adapters, each of which can be coupled to each other. Each microservice and adapter has a single responsibility. Such services follow both decomposition by capability and decomposition by subdomain patterns, based on whether the service is a core or ancillary service. It should be appreciated that the services and adapters communicate via the WAMP protocol (either RPC or Pub/Sub) using a well-defined message envelope.

Embodiments of architecture 200 can be understood with reference to FIG. 2. In an embodiment, a user device 204 such as a smart phone can connect with hub 212 via wireless connection 220 (e.g., via a local LAN if possible). Also, as a fallback position, the device 204 can connect via the cloud 216 using or through a WAMP websocket.

The hub 212 includes adapters 224, which are the interfaces to physical things such as but not limited to a sprinkler system. Hub 212 includes a WAMP router 228 having the websocket and raw socket. Hub 212 includes apps and microservices 232 and flow services 236. It should be appreciated that such list of adapters is for understanding and is not meant to be limiting.

Examples of adapters 224 include but are not limited to a Zigbee adapter 240 (e.g., for Zigbee door locks), an input module adapter 244 (e.g., a zone input adapter where a zone is a hardware device that connects to a home or premise's existing security systems), a hub relay adapter 248, a contact closure adapter 252, a notification adapter (e.g., push, SMS), and a keypad adapter 260. In an embodiment, contact closure adapter 252 knows about a door sensor and knows how to communicate with the door sensor and how to interpret the commands as open, closed, and battery low.

It should be appreciated that such adapters are analogous to device drivers, in the operating system analogy. Devices can be different hardware, such as USB, Zigbee, LoRA radio, for example. In an embodiment, the adapters are written in such a way as to connect to the physical device, an adaptation. On one side the adapter's API is exposed as WAMP and the other side is configured to call the actual hardware regardless of the implementation being Zigbee or LoRA or USB, etc.

In an embodiment, an adapter is a codebase that translates interfaces between the platform's APIs and individual device or device ecosystem APIs. The adapters have a “northbound” interface of WAMP and are expected to implement specific functions, such as “get device state” and “set device state.” The “southbound” interface can vary by adapter, but could be MQTT, HTTP, local daemon, etc to the device. The innovation's hub can come with adapters pre-installed for innovative platform's devices (e.g., contact closure and keypad). Additional adapters can be installed from an “adapter store.”

In an embodiment, an adapter includes a manifest (JSON) which includes properties such as adapter_id, name, input fields required for provisioning, permissions required, etc. An adapter announces its manifest to the resource manager upon startup and the resource manager stores it in its database.

In an embodiment, the innovative platform provides an Adapter SDK in several languages that accelerates the development of adapters for internal use and the developer community. An adapter is able to run in the cloud, on another device, or by a third party.

In an embodiment, an adapter's permissions allow it to register RPCs and publish messages within specific realms, such as for example the com.thing.adapter.[adapter_id] namespace.

### Third-Party Hardware Adapters

Typically, a home may have many subsystems, each with different protocols and authentications. For example, a user may have an entertainment system, surround system, different security system, and different garden or sprinklers systems. It should be appreciated that the innovation is an improvement because in accordance with embodiments herein, the user can connect such different subsystems. The user can create new hardware and have them be connectable via USB to the hub. The user writes a software adapter (e.g., adapter 224 of FIG. 2) for these different systems. A user can write an adapter for a sprinkler system that communicates via calls. The adapter can talk to the sprinkler system, whether it is by USB, Zigbee, WiFi, or custom protocols.

Referring back to FIG. 1, a third-party device is installed in a home or building. For example, hub 108 determines that the smart lock 172 is a third-party or legacy door lock. The third-party device can be a legacy device or be installed by a different entity than the entity installing the hub 108. In response to determining that the third-party device is installed, the one or more processors generate a new adapter for the third-party device. The embodiments thus solve the problem of legacy heating units, security cameras, or entertainment units not integrating with the architecture 100 shown by FIG. 1.

A new node corresponding to the third-party device is generated in the automated flow. In some embodiments, the node-based flow is used to define object-oriented (OO) classes or objects in an engine of the hub 108. Nodes are the primary building block of the automated flow. When the automated flow is running, messages are generated, consumed and processed by nodes. For example, nodes include code that runs in a JavaScript (.js) file, and an HTML file consisting of a description of the node, so that it appears in the node pane with a category, color, name and an icon, code to configure the node, and help text. Nodes can have an input, and zero or more outputs.

A smart device and a third-party device can be operated using a microservice to issue remote procedure calls (RPCs) from hub 108 via the adapter and the new adapter to the smart device and the third-party device over the hub's WAMP router 148 in accordance with the automated flow by referencing the new node and the node, while obviating communication between the hub 108 and the cloud computing system 104. For example, unlike with traditional RPCs, which are addressed directly from a caller to the entity offering the procedure (typically a server backend) and are strictly unidirectional (client-to-server), RPCs in WAMP are routed by a middleware and work bidirectionally. Registration of RPCs is with the hub's WAMP router 148, and calls to procedures are similarly issued to the hub's WAMP router 148. In some embodiments, a microservice uses pub/sub messaging from the hub via an adapter and a new adapter to a smart device and a third-party device, while obviating communication between the hub and the cloud.

A client microservice can issue RPCs via the single connection to the hub's WAMP router 148. The client microservice does not need to have knowledge of which client is currently offering a particular procedure, where that client resides, or how to address the client. The process can change between calls, opening up the possibility for advanced features such as load-balancing or fail-over for procedure calls. Additionally, the WAMP client microservices offer different procedures for calling. The different procedures avoid the traditional distinction between clients and server backends, and enable architectures where browser clients call procedures on other browser clients using an API similar to peer to peer communication.

The user device 204 is a smartphone, other mobile device, tablet, smartwatch, desktop, or laptop. The user device 204 has wireless connection 220 to the hub 212 via a local area network (LAN) or other short-range wired or wireless connection. The user device 204 has a fallback connection 216 to the cloud computing system 208. In some embodiments, the hub 212, multiple smart devices, and an adapter communicate using a 900 MHz wireless mesh network. The wireless mesh network is a communications network made up of radio nodes organized in a mesh topology. It can also be a form of wireless ad hoc network. For example, the mesh network uses LoRa communication.

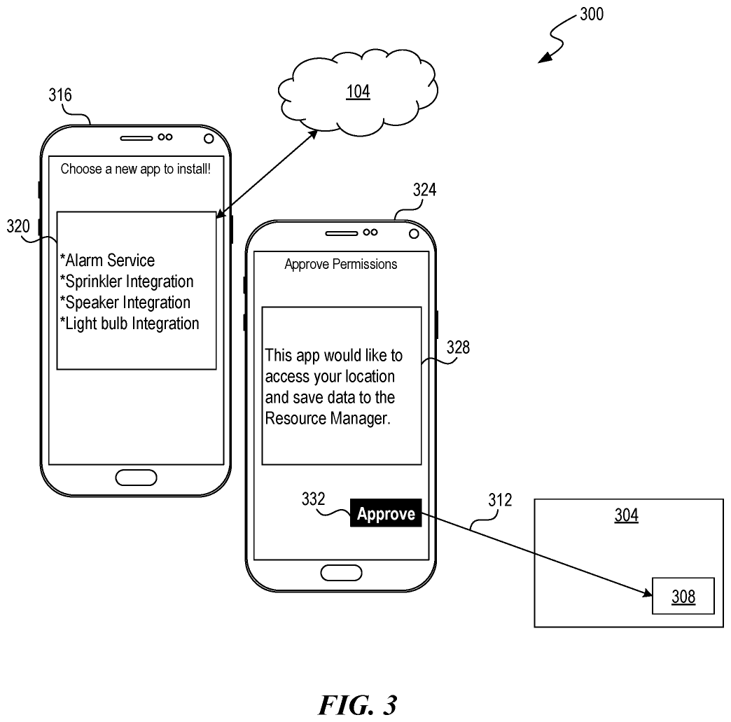

The hub 212 includes adapters 224, a WAMP router 228, applications and microservices 232, and flow services 236. Adapters are described in more detail with reference to FIGS. 3A, 3B, and 5. The hub 212 communicates with a WAMP router 124 in the cloud computing system 208 using the WAMP router 228. WAMP and WAMP routers are described in more detail with reference to FIG. 5.

In some embodiments, hub 212, the multiple smart devices (e.g., smart camera 168 illustrated and described in more detail with reference to FIG. 1), and adapter 224 each include a respective encryption module to encrypt the LoRa communication using a private cryptographic key stored in the hub 212 and a public cryptographic key stored in the cloud (e.g., using the cloud computing system 104 illustrated and described in more detail with reference to FIG. 1). An encryption module is a physical computing device that safeguards and manages secrets (most importantly digital keys), performs encryption and decryption functions for digital signatures, strong authentication and other cryptographic functions. The encryption module can be a plug-in card or an external device, and can contain one or more secure crypto-processor chips. The private cryptographic key (also known as a secret key) is a variable in cryptography that is used with an algorithm to encrypt and decrypt data, e.g., using symmetric cryptography or asymmetric cryptography.

The public cryptographic key can be a large numerical value used to encrypt data. The public cryptographic key can be generated by a software program or provided by a trusted, designated authority and made available via a publicly accessible repository or directory. In some embodiments, a private cryptographic key and a public cryptographic key are generated for encrypting communications between hub 212, multiple smart devices, and the cloud WAMP router 124. The public cryptographic key is stored in the cloud (e.g., using the cloud computing system 104 illustrated and described in more detail with reference to FIG. 1).

In some embodiments, a computer system implemented at the hub 212 detects that the hub 212 has lost external electrical power from the mains. The hub 212, the smart devices, third-party devices, and/or the wireless mesh network are powered using a 12 V uninterruptible power supply (UPS). For example, the UPS is embedded in a wall or floor of the home or building. A UPS or uninterruptible power source is an electrical apparatus that provides emergency power to a load when the input power source or mains power fails. A UPS provides near-instantaneous protection from input power interruptions, by supplying energy stored in batteries, supercapacitors, or flywheels. The on-battery run-time is relatively short (only a few minutes) but sufficient to start a standby power source or properly shut down the protected equipment.

Operative without Internet

In an embodiment, when there is no Internet service, the microservices can still run or execute inside the premises because there is the WAMP router (e.g., 148) on the hub (e.g., 108). In some embodiments, hub 212 determines that hub 212 has lost an Internet connection. Hub 212 causes a UI of a mobile application to send RPCs to hub 212 over the 900 MHz wireless mesh network. Example mobile apps 132 are illustrated and described in more detail with reference to FIG. 1. Hub 212 is connected to the cloud using an LTE or 5G connection of the user device 204. In some embodiments, the one or more processors detect that hub 212 has lost a connection to the cloud WAMP router 124. In response, a public key stored on user device 204 is used for encrypting communication between hub 212 and multiple smart devices (e.g., the smart lock 172 illustrated and described in more detail with reference to FIG. 1). The public key is a copy of a public cryptographic key used by the system according to the embodiments disclosed herein.

The adapter 240 is a Zigbee adapter. The adapter 240 enables Zigbee wireless connectivity with an RP-C controller, AS-P server, or AS-B server, extending the controller's or server's point count and bringing flexibility in retrofit applications. The adapter 244 is an input module adapter. The adapter 244 operates input modules that detect the status of input signals such as push-buttons, smart switches, or smart temperature sensors. The adapter 248 operates output modules such as hub relays. An output module controls devices such as relays, motor starters, or smart lights. The adapter 252 is a contact closure adapter. The adapter 252 operates contact closures designed for connecting smart switches, buttons, smart motion detectors, or other devices that make an electrical connection between two conductors. The adapter 252 operates digital outputs designed for connecting smart LED indicators, small relays, buzzers, pilot lights, and other devices powered from a small DC voltage.

The adapter 256 is a notification adapter. For example, the adapter 256 sends push notifications or clickable pop-up messages that appear on a user's browser irrespective of the device they're using or the browser they're on. The notifications serve as a quick communication channel enabling smart devices or the hub 212 to convey messages. In some embodiments, the adapter 256 sends Short Message Service (SMS) notifications or Multimedia Messaging Service (MMS) notifications to the user device 204. The notifications can include multimedia content such as videos, pictures, GIFs, and audio files. The adapter 260 is a keypad adapter and operates one or more keypads. The keypad can control a smart device such as the smart lock 172 illustrated and described in more detail with reference to FIG. 1 or send messages to the hub 212.

The applications and microservices 232 include a resource manager microservice 264. The microservice 264 serves as a registry (database) for adapters, services, groups, and devices. The microservice 264 exposes database create, read, update and delete (CRUD) operations via WAMP RPCs. An adapter or service manifest requests permissions that are approved by a user. Upon approval, the microservice 264 generates a dynamic authorization. A default permission exists to allow an adapter or service to publish within its own namespace. The microservice 284 is an activity service. A uniform resource identifier (URI) includes adapter identifiers (IDs) and/or Universally Unique Identifiers (UUlDs) for granular control of smart devices. In some embodiments, the UUIDS are 128-bit numbers, composed of 16 octets and represented as 32 base-16 characters, that can be used to identify information across a computer system. For example, the microservice 284 or a Mobile App on the user device 204 can access one or more events when given appropriate permissions. In some embodiments, an adapter, a smart device, and a microservice are added to a registry database. CRUD operations of the registry database are generated via RPCs.

### Provisioning Service

The microservice 268 is a provisioning service. The microservice 268 on-boards the hub 212 into a user's account. The microservice 268 allows the user to configure Wi-Fi settings over Bluetooth. The microservice 276 is a Groups Service. The microservice 276 allows groups to be used in automated flows. FBP is a programming paradigm that defines applications as networks of “black box” processes, which exchange data across predefined connections by message passing, where the connections are specified externally to the processes. These black box processes can be reconnected endlessly to form different applications without having to be changed internally. FBP is thus naturally component-oriented.

In an embodiment, the provisioning service 268 is responsible for on-boarding the local hub into the user's account. Such provisioning service 268 allows the user to configure wifi settings over bluetooth. The resource manager 264 is a microservice that serves as a registry (database) for adapters, services, groups, and devices. Such resource manager 264 exposes database CRUD operations via WAMP RPCs. The groups microservice 276 allows groups to be used in flows. Such groups microservice 276 subscribes to events for an element in a group and re-publishes such element events on the group topic. Such groups microservice 276 also allows the user to SET the state of the devices in a group that have a common capability set. The watchdog/bootstrap service 272 runs on the hub directly (not in a snap) and provides the following capabilities:
RPC to get a list of services/adapters (available snaps from an external repo—“st snap store”)
RPC to install a service/adapter
RPC to remove a service/adapter
RPC to get a list of running services/adapters
RPC to stop or start a service/adapter
RPC to control startup of a service/adapter (on hub boot)

* Startup priority/dependency tree, e.g. Start resource manager first, wait for health check, then start adapters.

As another example, the activity service 284 can inform the user that a particular person opened the door at 5 a.m. and that the alarm was set at 6 a.m. or that the alarm was triggered at 7 a.m. In an embodiment, the groups microservice 276 allows the user to group together devices. For example, groups microservice 276 can allow a user to group devices that are similar. As another example, the user can create logical groups such as a group of all the user's doors. As another example, the user can create a group of all the devices in the user's living room.

### Other Types Of Services

The innovation contemplates many other types of services. For example, machine learning-type services can be provided. A user can develop a machine learning-type service for detecting pets from the user's videos. The user can install such service and give it permission to access their video feed. Then, whenever the service detects an animal, such service can be configured to do something, an action. Further, such action can be configured with flows. Thus, the user can write a flow to address the user's desire to receive a text message every time a mountain lion comes into their backyard. Or the user can receive a push notification every time the microservice detects a rabbit in their backyard digging up plants or in the general area. Such flows are user configurable.

Put another way, the innovation allows the user to use different pieces, whether hardware or software, and then combine them in interesting ways using flows.

### Automated Flows

Flow service 236 is a control flow service runner that controls state machines for the platform's automations. Inside flow services 236, each flow (e.g., “get date and time 292” or “get weather 296”) performs tasks such as getting the current weather or turning on lights every night at 6 p.m. Flow is a visual programming language to write automations in the hub. The flow language allows exposing a multitude of nodes. Then different services can create their nodes and the user can connect such nodes together to do interesting tasks. For example, a flow can be created that follows the rule for when it detects a particular face, a notification of such can be spoken out of the speaker. As another example, the flow can be instructed that when the alarm goes off say between the hours of x and y, then send the robot dog to the front door. Such examples are straightforward automations that a user can write and the flow service (e.g., 236, 292, or 296) is an interpreter. Such flow can be considered like a programming language that is interpreting what is the flow and running or executing it.

In an embodiment, a flow service (e.g., flow service 236) is a codebase that provides non-core functions to the innovation's or platform's flows. The innovation's hub can come with services pre-installed for push notifications, weather, and more. As mentioned above, a service includes a manifest that includes triggers, conditions, and actions. Such flows can be explicitly defined by a schema as a set of setters and getters.

An automated flow can be generated in the cloud (e.g., using the cloud computing system 104 illustrated and described in more detail with reference to FIG. 1) using by user device 204. Operating a smart device (e.g., smart camera 168 illustrated and described in more detail with reference to FIG. 1) in accordance with the automated flow is performed in hub 212. FBP is a particular form of dataflow programming based on bounded buffers, information packets with defined lifetimes, named ports, and separate definition of connections. FBP defines applications using the metaphor of a “data factory.” It views an application as a network of asynchronous processes communicating by means of streams of structured data chunks, called “information packets.” In this view, the focus is on the application data and the transformations applied to it to produce the desired outputs. The network is defined externally to the processes, as a list of connections which is interpreted by a piece of software, usually called the “scheduler.” The processes communicate by means of fixed-capacity connections.

A connection is attached to a process by means of a port, which has a name agreed upon between the process code and the network definition. More than one process can execute the same piece of code. At any point in time, a given IP can only be “owned” by a single process, or be in transit between two processes. Ports may either be simple, or array-type, as used e.g. for the input port of a Collate component. It is the combination of ports with asynchronous processes that allows many long-running primitive functions of data processing, such as Sort, Merge, or Summarize to be supported in the form of software black boxes. In some embodiments, text or graphical input is received from a user input device communicably coupled to hub 212. The text or graphical input references a smart device (e.g., smart camera 168 illustrated and described in more detail with reference to FIGS. 1 and 5). A portion of the automated flow corresponding to the smart device is modified.

The microservice 276 subscribes to events for a device in a group and re-publishes those device events on the group topic. The microservice 276 also allows a user to set (e.g., using a SET command) the state of all devices in a group that have a common capability set. The microservice 272 is a watchdog or bootstrap microservice. The microservice 272 runs on the hub 212 directly (not in a Snap) and provides one or more of the following capabilities: (1) RPC to get a list of services/adapters (available Snaps from an external repo, e.g., “Snap store”), (2) RPC to install a service/adapter, (3) RPC to remove a service/adapter, (4) RPC to get a list of running services/adapters, (5) RPC to stop or start a service/adapter, and (5) RPC to control startup of a service/adapter (on hub boot), i.e., a startup priority/dependency tree, e.g., start resource manager first, wait for health check, then start adapters. The microservice 280 is an alarm service that provides functionality for alarms. The microservice 280 receives messages from one or more Alarm Gateways, and manages the current alarm states in the context of the equipment model, including the alarm lists associated with each smart device, e.g., smart lock 172.

The flow services 236 include a date and time service 292 and a weather service 296. A flow service 288 is a codebase that provides non-core functions to automated flows. The hub 212 has microservices pre-installed for push notifications, weather, and more. A microservice also includes a manifest that includes triggers, conditions, and actions. The triggers, conditions, and actions are explicitly defined by a schema as a set of setters and getters.

FIG. 3 is a drawing illustrating example microservices for an architecture 300, in accordance with one or more embodiments. The architecture 300 is similar to or the same as the architecture 300 illustrated and described in more detail with reference to FIG. 1. The architecture 300 is implemented using the components of the example computer system 600 illustrated and described in more detail with reference to FIG. 6. Likewise, embodiments of the microservices can include different and/or additional steps or can be ordered in different ways.

An embodiment of installing a microservice can be understood with reference to FIG. 3, a schematic diagram 300 showing how a user can install a microservice. Via their smart device 316 a user visits the innovation's “App Store” on the cloud 104 to see a list of new services 320 and integrations offered by the platform and third parties. Examples of such microservices as shown 320 include but are not limited to alarm service, sprinkler integration, speaker integration, and light bulb integration.

When a user selects an “app”, their device brings them to a new page 324, which prompts 328 the user to approve the permissions that the app is requesting. For example, the prompt might ask permission to access the user's location and to save user's data to the resource manager. The user is provided a UI 332, such as an Approve button, to indicate approval. Upon granting permissions, the app asks the Watchdog microservice 308 (running on the hub 304) to install the selected app. This request is made over WAMP 312. Such request is directed to the hub 304 if the user is in their home, otherwise such request is routed through the WAMP cloud router (not shown) to their hub 308. The watchdog microservice 308 then verifies the new app is approved and notarized by the platform and performs the installation. The system then guides the user through the provisioning process for the new service.

### Data Not Shared Between Microservices

In an embodiment, the system is configured to ensure privacy, that the user owns their data. The data stays on the hub (e.g., in database 144). The database in the cloud (e.g., 120) can be used for account services for example so that users can log in from the web. However, the data such as who went into the house, any faces recognized at the door, any kids coming in and out, any motion sensor detected, and video images captured that are considered private stay on the hub.

In an embodiment, microservice data is not shared between microservices either. For example, the alarm app cannot see or detect when someone opened the door unless the user specifically enabled an automation that uses such opening of the door as a trigger.

Such privacy is enabled because the services register RPC's and pub/subs. Permissions can be given on a granular scale to each pub/sub, each RPC. The services having granular permissions can be important when there are third party services. A user can install third party services written by any developer and the user can authorize the service just to see the step the service needs to do its work. Thus, for example, if a service doesn't need to access the camera, it will not be able to access the camera. As another example, if a service can't access the user's history of door openings and closes, such service will not be able to access such history of door openings and closes.

The architecture 300 includes two user devices 316, 324, a cloud computing system 104, and a hub 304. The cloud computing system 104 is illustrated and described in more detail with reference to FIG. 1. The hub 304 is similar to or the same as the hub 108 illustrated and described in more detail with reference to FIG. 1. The cloud computing system 104 includes an app store. A user visits the app store using the user device 316 to see a list of new services and integrations 320 offered by the cloud computing system 104 or third parties. When the user selects an “app,” they are prompted to approve the permissions 328 that the app is requesting, using one of the two user devices 316, 324. Upon granting permissions, the app 332 asks the Watchdog microservice 308 (running on the hub 304) to install the selected app. The microservice 308 is similar to or same as the microservice 272 illustrated and described in more detail with reference to FIG. 2.

The request 312 is made over WAMP. The request 312 is directed to the hub 304 if the user is in a home or building, otherwise the request 312 is routed through the WAMP cloud router 124 to the hub 304. The router 124 is described in more detail with reference to FIG. 1. The Watchdog microservice 308 verifies that the new app is approved and notarized, and performs the installation. The microservice 268 guides the user through the provisioning process for the new service. The microservice 268 is described in more detail with reference to FIG. 2.

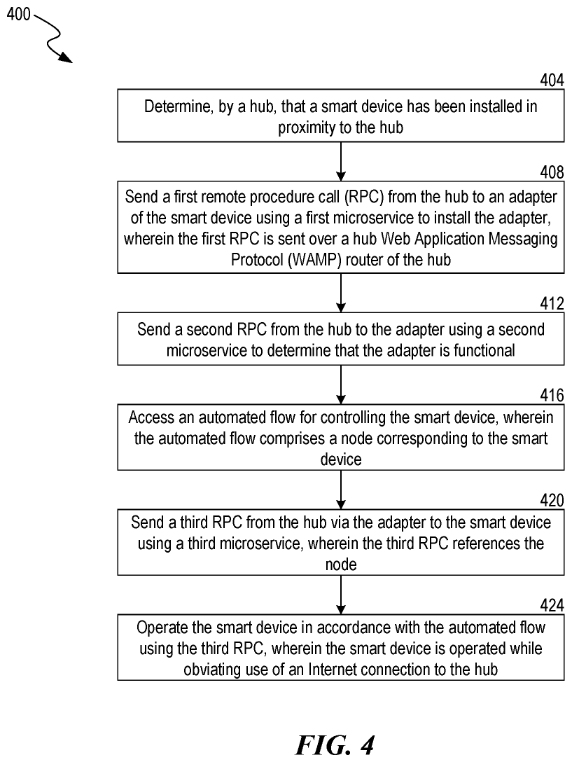

FIG. 4 is a flow diagram illustrating an example process 400, in accordance with one or more embodiments. In some embodiments, the process 400 of FIG. 4 is performed by the hub 108 illustrated and described in more detail with reference to FIG. 1. In some embodiments, the process 400 of FIG. 4 is performed by a computer system, e.g., the example computer system 600 illustrated and described in more detail with reference to FIG. 6. Particular entities, for example, microservices 136, perform some or all of the steps of the process in some embodiments. Microservices 136 are described in more detail with reference to FIG. 1. Likewise, embodiments can include different and/or additional steps, or perform the steps in different orders.

In step 404, a computer system of a hub determines that a smart device has been installed in proximity to the hub. Example hubs and example smart devices are illustrated and described in more detail with reference to FIGS. 1-3. The hub detects that a smart device has been plugged in using, e.g., short-range communication. Example short-range communication is described in more detail with reference to FIGS. 1-3. For example, the hub operates a computer program or provides an interface to detect addition of new smart devices to the architecture 100 illustrated and described in more detail with reference to FIGS. 1-3.

In step 408, the hub sends a first RPC from the hub to an adapter of the smart device using a first microservice to install the adapter. Example RPCs, example adapters, and example microservices are described in more detail with reference to FIGS. 1-3. The first RPC can be sent over a hub WAMP router of the hub. Example WAMP routers and transmission of RPCs are described in more detail with reference to FIGS. 1-3. In some embodiments, the hub sends a PubSub message via the adapter to the smart device using the first microservice. Example PubSub messages are described in more detail with reference to FIGS. 1-3.

In some embodiments, the first microservice is a resource manager microservice configured to register the adapter and the smart device. Example resource manager microservices and registration of adapters and smart devices is described in more detail with reference to FIGS. 1-3. For example, identifying data of the adapter and the smart device are added to a database referencing the hub by the first microservice. In some embodiments, the first microservice is configured to expose create, read, update, and delete (CRUD) operations. CRUD operations are described in more detail with reference to FIGS. 1-3. In some embodiments, the first microservice is a provisioning microservice configured to onboard the hub into a user account. Example provisioning microservices are described in more detail with reference to FIGS. 1-3.

In step 412, the hub sends a second RPC from the hub to the adapter using a second microservice to determine that the adapter is functional. For example, the second RPC causes a procedure or subroutine to execute in an address space on the adapter to determine that the adapter is functional. The second RPC is written as if it were a normal (local) procedure call, without a programmer explicitly writing the details for the remote interaction. This is a form of client-server interaction typically implemented via a request-response message-passing system.

In step 416, the hub accesses an automated flow for controlling the smart device. Automated flows and FBP are described in more detail with reference to FIGS. 1-3. The automated flow comprises a node corresponding to the smart device. Example nodes are described in more detail with reference to FIGS. 1-3. For example, the hub accesses the automated flow's asynchronous, concurrent processes, information packets with defined lifetimes, named ports, “bounded buffer” connections, and definitions of connections to the smart device. The flow is stored locally to the hub and is access by short-range communication.

In step 420, the hub sends a third RPC from the hub via the adapter to the smart device using a third microservice. The third RPC references the node. To improve data security of sensitive and personal data, the first microservice is precluded from sharing data with the second microservice and the third microservice. Moreover, sensitive and personal data is stored by the hub and not on the cloud. The hub can operate without a live connection to the cloud. In some embodiments, the third microservice is an activity microservice configured to access one or more events. Example activity microservices are described in more detail with reference to FIGS. 1-3.

In step 424, the hub operates the smart device in accordance with the automated flow using the third RPC. The smart device is operated while obviating use of an Internet connection to the hub. Operation of the hub and smart devices without an Internet connection to the hub is described in more detail with reference to FIGS. 1-3. For example, the smart device can be operated via different wireless protocols (such as Bluetooth, Zigbee, near-field communication, Wi-Fi, or LiFi). The smart device can be a smart speaker, a smart thermostat, a smart doorbell, a smart lock, or a smart refrigerator.

FIG. 5 is a block diagram illustrating an example machine learning (ML) system 500, in accordance with one or more embodiments. The ML system 500 is implemented using components of the example computer system 600 illustrated and described in more detail with reference to FIG. 6. For example, the ML system 500 can be implemented using instructions 628 programmed in the storage medium 626 illustrated and described in more detail with reference to FIG. 6. Likewise, embodiments of the ML system 500 can include different and/or additional components or be connected in different ways. The ML system 500 is sometimes referred to as a ML module.

The ML system 500 includes a feature extraction module 508 implemented using components of the example computer system 600 illustrated and described in more detail with reference to FIG. 6. In some embodiments, the feature extraction module 508 extracts a feature vector 512 from input data 504. The feature vector 512 includes features 512a, 512b, . . . , 512n. The feature extraction module 508 reduces the redundancy in the input data 504, e.g., repetitive data values, to transform the input data 504 into the reduced set of features 512, e.g., features 512a, 512b, . . . , 512n. The feature vector 512 contains the relevant information from the input data 504, such that events or data value thresholds of interest can be identified by the ML model 516 by using the reduced feature representation. In some example embodiments, the following dimensionality reduction techniques are used by the feature extraction module 508: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In alternate embodiments, the ML model 516 performs deep learning (also known as deep structured learning or hierarchical learning) directly on the input data 504 to learn data representations, as opposed to using task-specific algorithms. In deep learning, no explicit feature extraction is performed; the features 512 are implicitly extracted by the ML system 500. For example, the ML model 516 can use a cascade of multiple layers of nonlinear processing units for implicit feature extraction and transformation. Each successive layer uses the output from the previous layer as input. The ML model 516 can thus learn in supervised (e.g., classification) and/or unsupervised (e.g., pattern analysis) modes. The ML model 516 can learn multiple levels of representations that correspond to different levels of abstraction, wherein the different levels form a hierarchy of concepts. The different levels configure the ML model 516 to differentiate features of interest from background features.

In alternative example embodiments, the ML model 516, e.g., in the form of a convolutional neural network (CNN), generates the output 524, without the need for feature extraction, directly from the input data 504. The output 524 is provided to the computer device 528 or the hub 108 illustrated and described in more detail with reference to FIG. 1. The computer device 528 is a server, computer, tablet, smartphone, or smart speaker implemented using components of the example computer system 600 illustrated and described in more detail with reference to FIG. 6. In some embodiments, the steps performed by the ML system 500 are stored in memory on the computer device 528 for execution. In some embodiments, the output 524 is displayed on a screen of the hub 108 or smart devices 164, 168, 172 illustrated and described in more detail with reference to FIG. 1.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field can be approximated mathematically by a convolution operation. CNNs are based on biological processes and are variations of multilayer perceptrons designed to use minimal amounts of preprocessing.

The ML model 516 can be a CNN that includes both convolutional layers and max pooling layers. The architecture of the ML model 516 can be “fully convolutional,” which means that variable sized sensor data vectors can be fed into it. For all convolutional layers, the ML model 516 can specify a kernel size, a stride of the convolution, and an amount of zero padding applied to the input of that layer. For the pooling layers, the model 516 can specify the kernel size and stride of the pooling.

In some embodiments, the ML system 500 trains the ML model 516, based on the training data 520, to correlate the feature vector 512 to expected outputs in the training data 520. As part of the training of the ML model 516, the ML system 500 forms a training set of features and training labels by identifying a positive training set of features that have been determined to have a desired property in question, and, in some embodiments, forms a negative training set of features that lack the property in question.

The ML system 500 applies ML techniques to train the ML model 516, that when applied to the feature vector 512, the ML model 516 outputs indications of whether the feature vector 512 has an associated desired property or properties, such as a probability that the feature vector 512 has a particular Boolean property, or an estimated value of a scalar property. The ML system 500 can further apply dimensionality reduction (e.g., via linear discriminant analysis (LDA), principal component analysis (PCA), or the like) to reduce the amount of data in the feature vector 512 to a smaller, more representative set of data.

The ML system 500 can use supervised ML to train the ML model 516, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, or CNNs are used. In some example embodiments, a validation set 632 is formed of additional features, other than those in the training data 520, which have already been determined to have or to lack the property in question. The ML system 500 applies the trained ML model 516 to the features of the validation set 632 to quantify the accuracy of the ML model 516. Common metrics applied in accuracy measurement include: Precision and Recall, where Precision refers to a number of results the ML model 516 correctly predicted out of the total it predicted, and Recall is a number of results the ML model 516 correctly predicted out of the total number of features that had the desired property in question. In some embodiments, the ML system 500 iteratively re-trains the ML model 516 until the occurrence of a stopping condition, such as the accuracy measurement indication that the ML model 516 is sufficiently accurate, or a number of training rounds having taken place. The data enables the detected values to be validated using the validation set 332. The validation set 332 can be generated based on analysis to be performed.

In some embodiments, ML system 500 is a generative artificial intelligence or generative AI system capable of generating text, images, or other media in response to prompts. Generative AI systems use generative models such as large language models to produce data based on the training data set that was used to create them. A generative AI system is constructed by applying unsupervised or self-supervised machine learning to a data set. The capabilities of a generative AI system depend on the modality or type of the data set used. For example, generative AI systems trained on words or word tokens are capable of natural language processing, machine translation, and natural language generation and can be used as foundation models for other tasks. In addition to natural language text, large language models can be trained on programming language text, allowing them to generate source code for new computer programs. Generative AI systems trained on sets of images with text captions are used for text-to-image generation and neural style transfer.

FIG. 6 is a block diagram illustrating an example computer system 600, in accordance with one or more embodiments. Components of the example computer system 600 can be used to implement the hub 108 and other components illustrated and described in more detail with reference to FIG. 1. In some embodiments, components of the example computer system 600 are used to implement the ML system 500 illustrated and described in more detail with reference to FIG. 6. At least some operations described herein can be implemented on the computer system 600.

The computer system 600 can include one or more central processing units (“processors”) 602, main memory 606, non-volatile memory 610, network adapters 612 (e.g., network interface), video displays 618, input/output devices 620, control devices 622 (e.g., keyboard and pointing devices), drive units 624 including a storage medium 626, and a signal generation device 620 that are communicatively connected to a bus 616. The bus 616 is illustrated as an abstraction that represents one or more physical buses and/or point-to-point connections that are connected by appropriate bridges, adapters, or controllers. The bus 616, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The computer system 600 can share a similar computer processor architecture as that of a desktop computer, tablet computer, personal digital assistant (PDA), mobile phone, game console, music player, wearable electronic device (e.g., a watch or fitness tracker), network-connected smart device. A smart device is an electronic or electromechanical device, generally connected to other devices or networks via different wireless protocols such as Bluetooth, Zigbee, NFC, Wi-Fi, Li-Fi, or 5G that can operate to some extent interactively and autonomously, e.g., a smart television or home assistant device, virtual/augmented reality system, e.g., a head-mounted display, or another electronic device capable of executing a set of instructions (sequential or otherwise) that specify action(s) to be taken by the computer system 600.

While the main memory 606, non-volatile memory 610, and storage medium 626 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 628. The term “machine-readable medium” and “storage medium” shall also be taken to include any medium that is capable of storing, encoding, or carrying a set of instructions for execution by the computer system 600.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 604, 608, 628) set at various times in various memory and storage devices in a computer device. When read and executed by the one or more processors 602, the instruction(s) cause the computer system 600 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples can include machine-readable storage media, machine-readable media, or computer-readable media include recordable-type media such as volatile and non-volatile memory devices 610, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 612 enables the computer system 600 to mediate data in a network 614 with an entity that is external to the computer system 600 through any communication protocol supported by the computer system 600 and the external entity. The network adapter 612 can include a network adapter card, a wireless network interface card, a router, an access point, a wireless router, a switch, a multilayer switch, a protocol converter, a gateway, a bridge, a bridge router, a hub, a digital media receiver, and/or a repeater.

The network adapter 612 can include a firewall that governs and/or manages permission to access proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

The functions performed in the processes and methods can be implemented in differing order. Furthermore, the outlined steps and operations are only provided as examples, and some of the steps and operations can be optional, combined into fewer steps and operations, or expanded into additional steps and operations without detracting from the essence of the disclosed embodiments.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), or field-programmable gate arrays (FPGAs).

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms can be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms can on occasion be used interchangeably.

Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

I/We claim:

1. A computer-implemented method comprising:
determining, by a computer system of a hub, that a smart device has been installed in proximity to the hub;
sending a first remote procedure call (RPC) from the hub to an adapter of the smart device using a first microservice to install the adapter,
wherein the first RPC is sent over a hub Web Application Messaging Protocol (WAMP) router of the hub;
sending a second RPC from the hub to the adapter using a second microservice to determine that the adapter is functional;
accessing an automated flow for controlling the smart device,
wherein the automated flow comprises a node corresponding to the smart device;
sending a third RPC from the hub via the adapter to the smart device using a third microservice,
wherein the third RPC references the node; and
operating the smart device in accordance with the automated flow using the third RPC,
wherein the smart device is operated while obviating use of an Internet connection to the hub.

2. The computer-implemented method of claim 1, comprising:
sending a Publish/Subscribe (PubSub) message from the hub via the adapter to the smart device using the first microservice.

3. The computer-implemented method of claim 1, wherein the first microservice is a resource manager microservice configured to register the adapter and the smart device.

4. The computer-implemented method of claim 1, wherein the first microservice is configured to expose create, read, update, and delete (CRUD) operations.

5. The computer-implemented method of claim 1, wherein the first microservice is precluded from sharing data with the second microservice and the third microservice.

6. The computer-implemented method of claim 1, wherein the third microservice is an activity microservice configured to access one or more events.

7. The computer-implemented method of claim 1, wherein the first microservice is a provisioning microservice configured to onboard the hub into a user account.

8. A computer system comprising:
one or more computer processors; and
a non-transitory, computer-readable storage medium storing instructions, which when executed by at least one of the one or more computer processors cause the computer system to:
determine, by a hub, that a smart device has been installed in proximity to the hub;
send a first remote procedure call (RPC) from the hub to an adapter of the smart device using a first microservice to install the adapter,
wherein the first RPC is sent over a hub Web Application Messaging Protocol (WAMP) router of the hub;
send a second RPC from the hub to the adapter using a second microservice to determine that the adapter is functional;
access an automated flow for controlling the smart device,
wherein the automated flow comprises a node corresponding to the smart device;
send a third RPC from the hub via the adapter to the smart device using a third microservice,
wherein the third RPC references the node; and
operate the smart device in accordance with the automated flow using the third RPC,
wherein the smart device is operated while obviating use of an Internet connection to the hub.

9. The computer system of claim 8, wherein the instructions cause the computer system to send a Publish/Subscribe (PubSub) message from the hub via the adapter to the smart device using the first microservice.

10. The computer system of claim 8, wherein the first microservice is a resource manager microservice configured to register the adapter and the smart device.

11. The computer system of claim 8, wherein the first microservice is configured to expose create, read, update, and delete (CRUD) operations.

12. The computer system of claim 8, wherein the first microservice is precluded from sharing data with the second microservice and the third microservice.

13. The computer system of claim 8, wherein the third microservice is an activity microservice configured to access one or more events.

14. The computer system of claim 8, wherein the first microservice is a provisioning microservice configured to onboard the hub into a user account.

15. A non-transitory, computer-readable storage medium storing instructions, which when executed by one or more computer processors cause the one or more computer processors to:
determine, by a hub, that a smart device has been installed in proximity to the hub;
send a first remote procedure call (RPC) from the hub to an adapter of the smart device using a first microservice to install the adapter,
wherein the first RPC is sent over a hub Web Application Messaging Protocol (WAMP) router of the hub;
send a second RPC from the hub to the adapter using a second microservice to determine that the adapter is functional;
access an automated flow for controlling the smart device,
wherein the automated flow comprises a node corresponding to the smart device;
send a third RPC from the hub via the adapter to the smart device using a third microservice,
wherein the third RPC references the node; and
operate the smart device in accordance with the automated flow using the third RPC,
wherein the smart device is operated while obviating use of an Internet connection to the hub.

16. The non-transitory, computer-readable storage medium of claim 15, wherein the instructions cause the one or more computer processors to:
send a Publish/Subscribe (PubSub) message from the hub via the adapter to the smart device using the first microservice.

17. The non-transitory, computer-readable storage medium of claim 15, wherein the first microservice is a resource manager microservice configured to register the adapter and the smart device.

18. The non-transitory, computer-readable storage medium of claim 15, wherein the first microservice is configured to expose create, read, update, and delete (CRUD) operations.

19. The non-transitory, computer-readable storage medium of claim 15, wherein the first microservice is precluded from sharing data with the second microservice and the third microservice.

20. The non-transitory, computer-readable storage medium of claim 15, wherein the third microservice is an activity microservice configured to access one or more events.
